(19) United States
(12) Patent Application Publication
(10) Pub. No.: US 2008/0141727 A1
(43) Pub. Date: Jun. 19, 2008

(54) Refractory system for bushing assembly

(76) Inventors: Timothy A. Sullivan, Newark, OH (US); Byron L. Bemis, Newark, OH (US); David F. Purvis, Newark, OH (US)

Correspondence Address: OWENS CORNING, 2790 COLUMBUS ROAD, GRANVILLE, OH, 43023, US

(21) Appl. No.: 11/638,757

(22) Filed: Dec. 14, 2006

(51) Int. Cl. C03B 37/08

(52) U.S. Cl. 65/498; 65/495; 264/261

(57) ABSTRACT

A fiber forming bushing assembly includes a frame and a bushing within the frame. One or more sections formed of a pre-cast refractory material are positioned between at least a lower sidewall of the bushing and the frame.

### TECHNICAL FIELD AND INDUSTRIAL APPLICABILITY OF THE INVENTION

This invention relates generally to a refractory system for producing continuous filaments, and in particular, to a bushing assembly in a filament forming apparatus. The invention is useful in the production of continuous glass filaments and mineral fibers.

### BACKGROUND OF THE INVENTION

A bushing used in the production of filaments or fibers has thin metal sidewalls and end walls and a bottom that form a heating chamber. The heating chamber is surrounded with an insulation material. The bottom has bushing tips therein, from which molten material is attenuated to produce the fibers. The walls and bottom are made of precious metal, usually a platinum alloy, capable of withstanding the elevated operating temperature of the bushing. The end walls of the bushing have electrical terminals or ears thereon between which current is passed through the bushing walls to heat the same to the operating temperature.

During the fiber forming operation, the bushing walls tend to expand at a greater rate than the surrounding insulation material. Since the expansion of the metal walls is physically restrained by the insulation material, there was a tendency for the metal walls to buckle or crack. This was particularly true in thin-walled, larger bushings; for example, those holding over ten pounds of molten material and having several thousand bushing tips in the bottom. Even if physical changes did not occur in the walls of the bushings, there was often excessive stress produced that resulted in poor operating performance of the bushings and/or premature failure of the bushings, requiring earlier replacement thereof.

In the past, the insulation material had been made from pourable cast materials that tended to vary in moisture and composition content from batch to batch. This caused concerns since an increased moisture level of the insulation material has an adverse affect on the strength and integrity of the insulation material. In particular, such insulation materials tend to crack and separate from the bushing and frame, resulting in premature failure of the bushing. In addition, the use of the cast materials increased down time of the fiber forming apparatus since the insulation material needs to set and cure, often taking days to cure. Therefore, each batch of the resulting insulation materials tended to have different thermal properties. Any inconsistency that occurs in the making of the insulation materials can cause undesirable variations in the strength and/or thermal properties of the insulation materials themselves.

There is still a need to further improve the fiber-forming bushing construction so that the metal walls of the bushing are less subjected to stress.

Also, it is desired to provide a bushing that has a longer life and better operating performance.

### SUMMARY OF THE INVENTION

A fiber forming bushing assembly includes a bushing and one or more sections formed of refractory material positioned around the bushing. The sections of refractory material are a pre-cast material and may comprise a fired ceramic material. In certain embodiments, the fiber forming bushing assembly further includes a castable refractory material positioned around the sections of pre-cast refractory material.

In another aspect, a method of making a fiber forming bushing assembly includes producing a chamber having lower sidewalls, placing one or more sections of a refractory material around the outside of the lower sidewalls, and heating at least the lower sidewalls to an elevated operating temperature.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings.

FIG. 1 is a side elevational view, in cross-section, of a first embodiment of a bushing and frame assembly.

FIG. 2 is a side elevational view, in cross-section, of a second embodiment of a bushing and frame assembly.

FIG. 3 is a side elevational view, in cross-section, of a third embodiment of a bushing and frame assembly.

FIG. 4 is a schematic plan view of the first embodiment of the bushing and frame assembly showing multiple refractory sections positioned around the bushing.

FIG. 5 is a schematic view, taken along the line 5-5 in FIG. 3, of the bushing and frame assembly showing multiple refractory sections positioned around the bushing and showing a castable material within the frame.

### DETAILED DESCRIPTION AND PREFERRED EMBODIMENTS OF THE INVENTION

As will be readily appreciated by those skilled in the art, the description herein includes generally a schematic representation of one suitable manufacturing method for producing glass or mineral fibers.

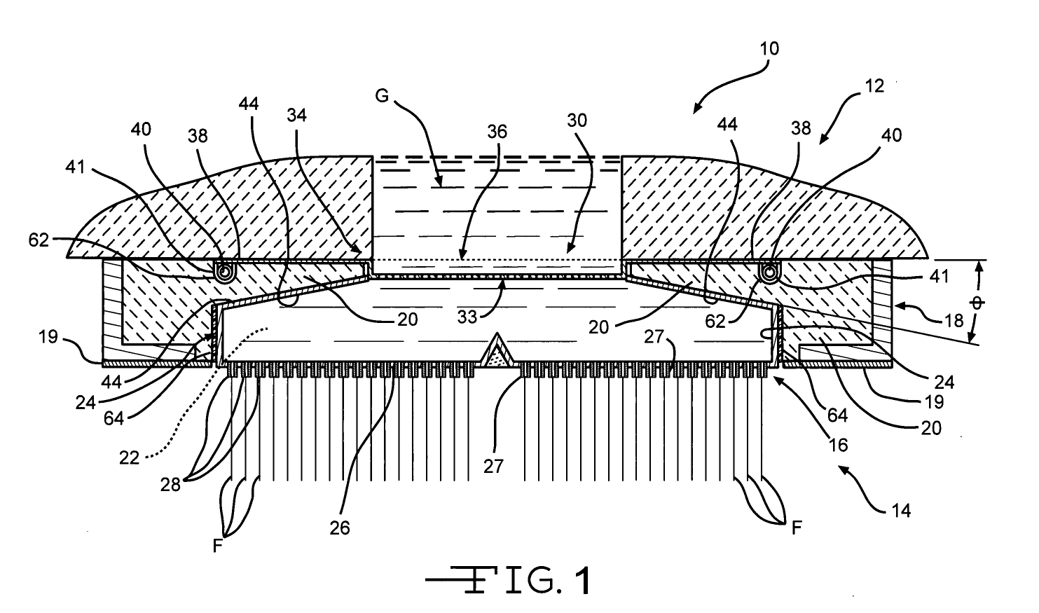

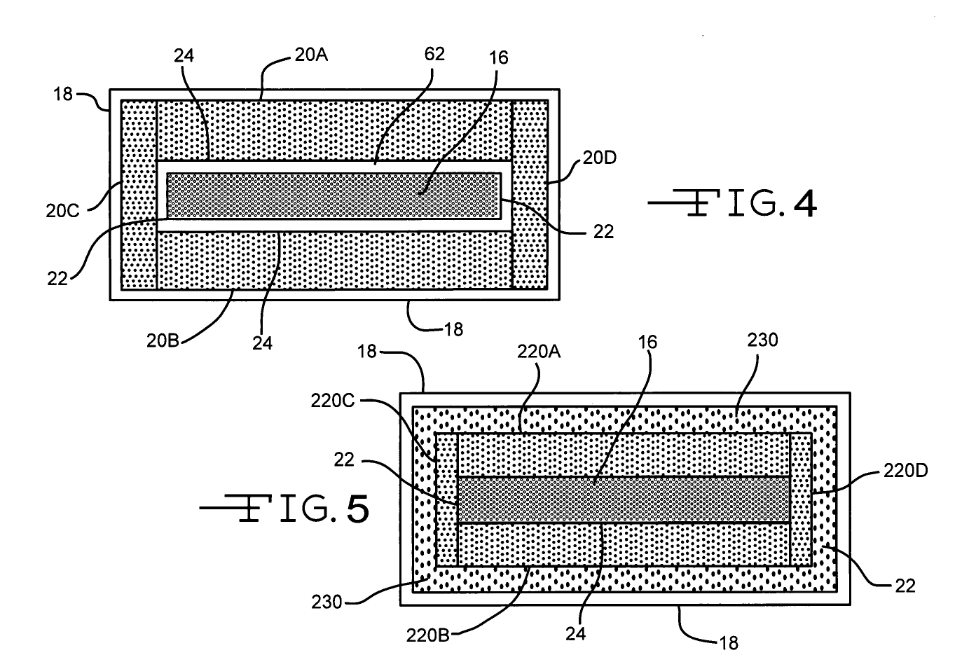

Referring now to the drawings, there is illustrated in FIG. 1 one embodiment of a fiber forming assembly 10 comprising a bushing block 12 and a bushing assembly 14. The bushing assembly 14 includes a bushing 16 and a frame 18 about the bushing 16. The bushing assembly 14 further includes a plurality of pre-cast or fired refractory material sections 20 positioned in a space between the frame 18 and the bushing 16, as schematically illustrated in FIG. 4, and further explained below.

The bushing 16 is basically comprised of an electrically conductive material. In certain embodiments, the bushing 16 is in the form of a metal box having an elongate, substantially rectangular shape. As schematically illustrated in FIG. 4, the bushing 16 is defined, in part, by opposing end walls 22 and opposing elongated lower sidewalls 24 extending in a longitudinal direction between the end walls 22. Referring again to FIG. 1, the bushing 16 also includes upper slanted sidewalls 44 that extend inwardly from the lower sidewalls 24.

The bushing 16 has a bottom perforated tip plate 26 having a plurality of orifices 27 formed therein and can include tips or tubular members 28. The tip plate 26 extends in a side-to-side or longitudinal direction between the end walls 22 and a front to rear or lateral direction between the sidewalls 24. An opening or throat 30 is provided at the top of the bushing 16 for receiving the molten material G from the bushing block 12. In certain embodiments, a perforated screen 33 is positioned at a bottom of the throat 30.

Opposing electrical terminals or ears 13 are attached to the opposing end walls 22. The ears are adapted to be connected to a source of current (not shown) so that current can flow through the ears and further into and through the walls of the bushing 16. The resistance to current flow heats the bushing 16, thereby maintaining the glass G under the desired thermal conditions.

In the embodiment shown, a flange 34 extends from a top of the throat 30. The flange 34 includes a lateral portion 36 that extends in the lateral direction adjacent each of the end walls 22 and an elongate portion 38 that extends in the longitudinal direction adjacent each of the elongate sidewalls 24. The flange 34 engages an underside of the bushing block 12 to form a seal between the bushing block 12 and the flange 34 to prevent molten material G from escaping or leaking from between the bushing block 12 and the flange 34. In certain embodiments, to further reduce the risk that molten material G will escape from between the bushing block 12 and the flange 34, a cooling coil 40 is attached to the flange 34. In certain embodiments, the cooling coil 40 is a continuous cooling coil that is attached to an outer peripheral edge of the flange 34.

In the embodiment schematically illustrated in FIG. 4, a plurality of refractory sections 20A, 20B, 20C and 20D surround at least the lower sidewalls 24 and the end walls 22 to insulate the bushing 16 and to provide support for the bushing 16 at its elevated operating temperatures. In the embodiment shown in FIG. 4, the refractory sections 20A and 20B extend longitudinally along the lower sidewalls 24 of the bushing 16. The refractory sections 20C and 20D extend along the end walls 22 and, in certain embodiments, may be provided with recesses (not shown) for electric terminals (not shown). It is to be understood that, in other embodiments, other numbers and other configurations of refractory sections 20 are also useful and are within the contemplated scope of the present invention.

The refractory sections 20 provide a continuous rigid structural support for the bushing 16. The thick refractory sections 20 surround the bushing 16 to provide both an insulating effect and structural support for the bushing 16.

In the embodiment shown in FIG. 1, the refractory sections 20 also provide structural support for the elongate portion 38 of the flange 34. The refractory sections 20 maintain the rigidity and shape of the flange 34 during the operation of the bushing 16. The refractory sections 20 prevent each elongate portion 38 of the flange 34 from collapsing during the service life of the bushing 16. Also, a proper seal is maintained between the underside of the bushing block 12 and each elongate portion 38 of the flange 34, thus minimizing the gap between the underside of the bushing block 12 and each elongate portion 38 of the flange 34. This, in turn, reduces the risk of glass leaking between the bushing block 12 and each elongate portion 38 of the flange 32. Any leakage that may occur will be solidified by the cooling coil 40.

It should also be understood that, in certain embodiments, an upper surface of the refractory sections 20 can define one or more channels or recesses 62. The channel 62 is configured to receive or mate with the cooling coil 40 in the flange 34.

In certain embodiments, the refractory sections 20 are formed from a non-deteriorating material that has a desired resistance to high temperatures. The refractory sections 20 can be made of a fired ceramic material. In general, the fired ceramic materials are fired to high temperatures, typically in the range of 1500° C. to 2400° C. and even higher. The fired ceramic refractory sections 20 can be finished to precise tolerances. Finishing techniques for the fired ceramic refractory sections 20 can include, for example, laser, water jet and diamond cutting, diamond grinding and drilling. In certain embodiments, the refractory sections 20 can be “net formed” or formed to meet a predetermined acceptable tolerance to minimize machining.

The fired ceramic refractory sections 20 can have tensile strengths capable of withstanding stress endured by the elongate portion 38 of the flange 34 over its entire span and capable of maintaining rigidity during the service life of the bushing 16. In other embodiments, the refractory sections 20 may be formed from a material capable of withstanding high temperatures other than a ceramic material. Moreover, the refractory sections 20 may be formed from a composite material, such as a ceramic matrix with a high-temperature high-strength fiber reinforcement.

In certain embodiments, the refractory sections 20 are spaced away from the frame 18 at a short distance in order to allow the bushing walls 24 and the end walls 22 to expand when heated. Thus, the heated bushing 16 fills the space initially provided between the bushing walls 24 and end walls 22 and the refractory sections 20. This enables the metal lower sidewalls 24 and end walls 22 to fully expand at their own rate without resulting in stresses therein.

Also, in certain embodiments, an expansion material 64 can be placed between the refractory sections 20 and the bushing 16. In certain embodiments, the expansion material is positioned adjacent to the lower sidewalls 24 and end walls 22. In a particular embodiment, the expansion material 64 can include one or more layers of a removable material such as, for example, a polyethylene foam, wax or paraffin material. In another particular embodiment, the expansion material 64 can include a compressible material such as, for example, a ceramic fiber felt material. The thickness of the expansion material 64 can depend, in part, on the operating parameters of the fiber forming assembly 10. For example, the dimensions of the bushing end walls 22 and sidewalls 24 and the coefficient of expansion of the metal forming the end walls 22 and sidewalls 24 can be used to calculate the total dimensional changes of the bushing lower sidewalls 24 and end walls 22 between room temperature and operating temperature. The dimensional changes of the refractory sections 20 can be similarly determined. The width of the space between the bushing walls 24 and the refractory sections 20 can then be calculated to determine the amount of relief needed for the bushing walls. In certain embodiments, for example, for a particular bushing holding fifteen pounds of molten material and having four thousand bushing tips, the layers along the lower sidewalls 24 of the bushing can be about 1/16th inch (about 0.15 cm) thick and the layers 64 at the end walls 24 of the bushing can be about ⅛ inch (about 0.3 cm) thick such that the bushing expands longitudinally more than transversely.

As the bushing 16 is then heated to operating temperature, the expansion material forming the layers 64 can be removed (i.e., melted, in the case of the foam, wax or paraffin material; or i.e., compressed, in the case of a felt material). At the same time, the resulting space between the lower sidewalls 24 and end walls 22 and the refractory sections 20 diminishes. With the proper spacing, the space diminishes substantially to zero, when the bushing operating temperature is reached.

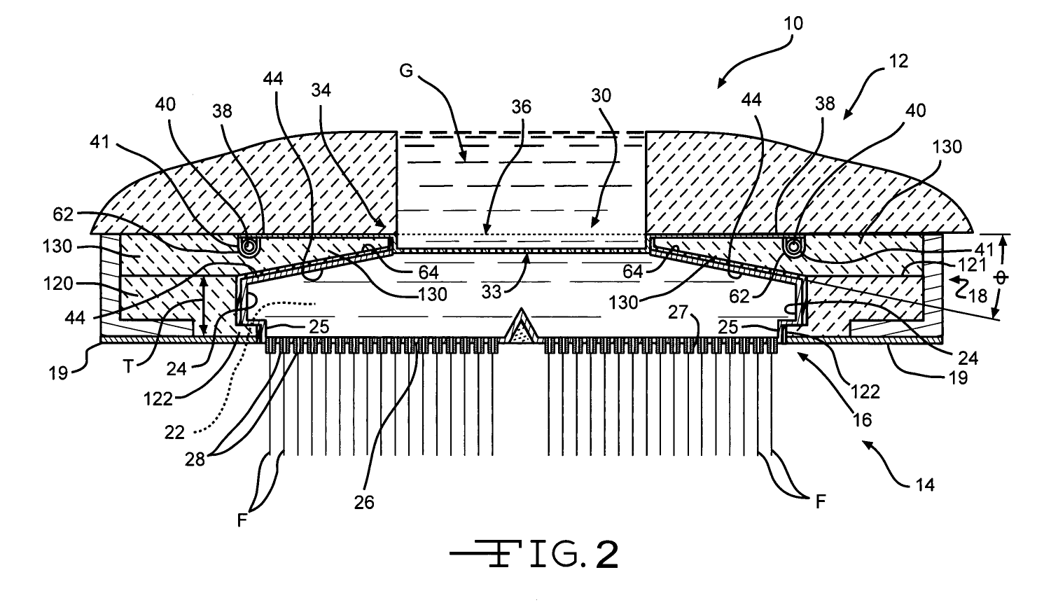

The shapes of the refractory sections 20 can vary and the present embodiment shown is not intended to be limiting. The high-strength pre-cast refractory sections 20 eliminate prior concerns where it was sometimes difficult to ensure a continuous backfill of the material in all the spaces between the bushing 16 and the frame 18. In certain embodiments, for example, as shown in FIGS. 1 and 2, the pre-cast refractory section can be made with a complicated shape that is complementary to the shape of the bushing 16. The refractory sections 20 can have shapes other than merely rectangular, and can have one or more corners, edges, beveled, angles, recesses, slanted sides and the like. For example, the refractory sections 20 shown in the FIGS. 1 and 2 herein, can be made with inwardly extending portions that are configured with a cross-sectional geometry that allows the pre-cast refractory section to hold the flanges 34 in a spaced apart manner from the slanted sidewalls 44 of the bushing 16.

Also, the use of the refractory sections 20 that are made of pre-cast materials eliminates problems that occurred in the past due to the differences in the moisture content among batches of the prior art insulation material.

For example, the refractory sections 20 can have rounded corners or relatively sharp corners. Moreover, the ends of the refractory sections 20 can be squared off or rounded, similar to the rounded corners. Also, in certain embodiments, the refractory sections 20 can be made with interlocking or keyed segments in order to hold adjacent sections of the refractory sections 20 firmly in place.

Referring now to another embodiment shown in FIG. 2, it is to be noted that, for the same or similar structures as shown in FIG. 1, the same reference numbers will be used for ease of explanation. In the embodiment in FIG. 2, one or more refractory sections 120 are positioned adjacent at least the lower sidewalls 24.

The refractory sections 120 can have a thickness T that is narrower than the height of a cavity between a base plate 19 of the frame 18 and the bushing block 12. In the embodiment shown in FIG. 2, the refractory section 120 has a lower inwardly extending ledge 122. The ledge 122 is configured with a suitable geometry that allows the refractory section 120 to at least partially hold the bushing 16 that has a complicated shape, as shown in FIG. 2, where at least the sidewall 24 of the bushing 16 includes a lower indentation 25.

In certain embodiments, additional refractory sections 120 can be positioned adjacent the end walls 22 of the bushing 16 such that the refractory sections 120 are circumferentially positioned around the bushing 16.

In a particular embodiment, a castable material 130 can be poured or otherwise juxtaposed on a top surface 121 of the refractory sections 120 and the frame 18. The castable material 130 flows into the cavity created by the frame 18, the refractory sections 120 and at least the slanted sidewalls 44. In certain embodiments, at least a portion of the sidewalls 24 can also form a part of the castable material cavity. The thickness of the castable material 130 can depend, in part, on the strength needed to firmly support the bushing 16.

In certain embodiments, the use of both the refractory sections 120 and the castable material 130 in the fiber forming assembly 10 decreases the costs of manufacturing and maintaining the fiber forming assembly 10, while still maintaining the needed strength and support of the bushing assembly 14. The use of a suitable castable material 130 with the pre-cast sections 120 provides for a quick turn-around time when it is necessary to replace the bushing 16. The combination of the refractory sections 120 and the castable material 130 provides a bushing assembly 14 and also maintains the desired thermal properties that are needed during the fiber forming operation.

In certain embodiments, a suitable setting or curing accelerant material can be added to the castable material 130 to further decrease the time needed for the castable material to set and/or cure. Also, while not shown, in certain embodiments, the castable material 130 can be positioned between the bushing 16 and the pre-cast refractory sections 120.

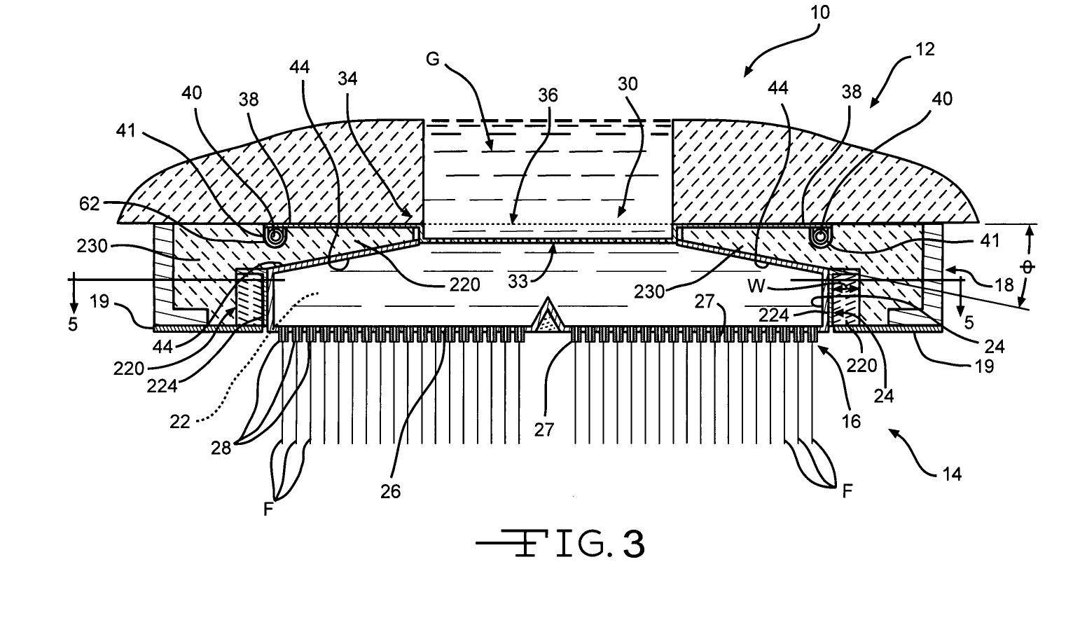

Referring now to another embodiment shown in FIG. 3, it is to be noted that, for the same or similar structures as shown in FIG. 1, the same reference numbers will be used for ease of explanation. In the embodiment in FIG. 3, one or more refractory sections 220 are positioned adjacent at least the lower sidewalls 24. The refractory sections 220 can have a width W that is narrower than the width of a cavity between sidewalls 24 of the bushing 16 and the frame 18. In the embodiment shown in FIG. 3, the refractory section 220 has a generally rectangular cross-sectional shape and is held in position by an outwardly extending projection 224 that is secured to the lower sidewalls 24. The outwardly extending projection 224 and the refractory sections 220 are configured with suitable geometries that allow the refractory sections 220 to hold a bushing 16 that has a complicated shape. In the embodiment shown in FIG. 3, the outwardly extending projection 224 has an “inverted L” cross-sectional shape. Also, while not shown in FIG. 3, it is to be understood that expansion materials can be positioned between the outwardly extending projection 224 and the pre-cast refractory sections 220.

In certain embodiments, additional refractory sections 220 can be positioned adjacent the end walls 22 of the bushing 16 such that the refractory sections 220 are circumferentially positioned around the bushing 16.

A castable material 230 can be poured into a cavity between the refractory sections 220 and the frame 18. Similarly, in this embodiment, the use of both the refractory sections 220 and the castable material 230 decreases the costs, while maintaining the needed strength and support of the bushing assembly 14. The use of a castable material 230 with the pre-case refractory sections 220 provides for a quick turn-around time when it is necessary to replace the bushing 16. The combination of the refractory sections 220 and the castable material 230 provides a bushing assembly where the desired strength and thermal properties are maintained, while decreasing the costs and time associated with replacing the bushing 16 within the bushing assembly 14. Similarly, in this embodiment, a suitable accelerant material can be added to the castable material 230 to further decrease the time needed for the castable material to set and/or cure. Also, while not shown, in certain embodiments, the castable material 230 can be positioned between the bushing 16 and the pre-cast refractory sections 220.

As schematically illustrated in FIG. 5, the bushing 16 is defined, in part, by opposing end walls 22 and opposing elongated lower sidewalls 24 extending between the end walls 22. A plurality of refractory sections 220A, 220B, 220C and 220D surround at least the lower sidewalls 24 and the end walls 22 to insulate the bushing 16 and to provide support for the bushing 16 at its elevated operating temperatures. In the embodiment shown in FIG. 5, the refractory sections 220A and 220B extend longitudinally along the lower sidewalls 24 of the bushing 16. The refractory sections 220C and 220D extend along the end walls 22 and, in certain embodiments, may be provided with recesses (not shown) for electric terminals (not shown). It is to be understood that, in other embodiments, other numbers and other configurations of refractory sections 220 are also useful and are within the contemplated scope of the present invention.

While the invention has been described with reference to various and preferred embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiment disclosed herein contemplated for carrying out this invention, but that the invention will include all embodiments falling within the scope of the claims.

What is claimed is:

1. A fiber forming bushing assembly comprising a frame, a bushing at least partially positioned within the frame, the bushing includes a bottom perforated plate, and having
one or more sections formed of a pre-cast refractory material at least partially positioned between the bushing and the frame.

2. The fiber forming bushing assembly of claim 1, wherein the sections of pre-cast refractory material comprise a high strength pre-cast material.

3. The fiber forming bushing assembly of claim 1, wherein the sections of pre-cast refractory material comprise a fired ceramic material.

4. The fiber forming bushing assembly of claim 1, further including a castable material positioned between the frame and the pre-cast refractory sections.

5. The fiber forming bushing assembly of claim 1, further including a castable material positioned between the bushing and the frame and on a top surface of the sections of pre-cast refractory material.

6. The fiber forming bushing assembly of claim 1, wherein at least one pre-cast refractory section has a lower inwardly extending ledge configured with a geometry that allows the pre-cast refractory section to at least partially hold the bushing.

7. The fiber forming bushing assembly of claim 1, wherein the bushing includes an outwardly extending projection, wherein the outwardly extending projection is configured with a geometry that at least partially holds the pre-cast refractory section adjacent to the bushing.

8. The fiber forming bushing assembly of claim 1, including an expansion material between the sections of pre-cast refractory material and the bushing.

9. The fiber forming assembly of claim 1, wherein the pre-cast refractory sections circumferentially extend around the bushing.

10. The fiber forming assembly of claim 1, further comprising a cooling coil mounted to the bushing, wherein one or more pre-cast refractory sections includes a recess configured to accept at least a portion of the cooling coil.

11. A method of making a fiber forming bushing assembly comprising:
producing a bushing having a perforated bottom, the bushing being at least partially positioned in a frame, and
positioning one or more sections of a pre-cast refractory material between the bushing and the frame.

12. The method of claim 11, further including placing an expansion material adjacent to at least a portion of the bushing prior to positioning the pre-cast refractory material between the bushing and the frame.

13. The method of claim 11, further including placing a castable material adjacent to the pre-cast refractory material, and allowing the castable material to set.

14. The method of claim 13, including placing the castable material on a top surface of the pre-cast refractory material.

15. The method of claim 13, including placing the castable material between the pre-cast refractory material and the frame.

16. A fiber forming bushing assembly comprising a frame and a bushing at least partially positioned within the frame, the bushing being defined at least in part by lower sidewalls and a perforated plate beneath the lower sidewalls, and having
one or more sections formed of a pre-cast refractory material positioned between the lower sidewalls and the frame, and
a castable material positioned between the frame and the pre-cast refractory sections.

17. The fiber forming bushing assembly of claim 16, wherein the castable material is positioned on a top surface of one or more of the pre-cast refractory sections.

18. The fiber forming bushing assembly of claim 16, wherein at least one pre-cast refractory section has a lower inwardly extending ledge configured with a geometry that allows the refractory section to at least partially hold the bushing.

19. The fiber forming bushing assembly of claim 16, wherein the bushing includes an outwardly extending projection that is secured to the lower sidewalls, wherein the outwardly extending projection is configured with a geometry that at least partially holds the pre-cast refractory section adjacent to the bushing

20. The fiber forming bushing assembly of claim 16, including an expansion material between the sections of pre-cast refractory material and the lower sidewalls.

21. The fiber forming assembly of claim 16, wherein the pre-cast refractory sections circumferentially extend around the lower sidewalls and around opposing end walls of the bushing.

22. The fiber forming assembly of claim 16, further comprising a cooling coil mounted to the bushing, wherein one or more of the pre-cast refractory sections includes a recess configured to accept at least a portion of the cooling coil.
